(19) United States
(12) Patent Application Publication
(10) Pub. No.: US 2010/0248183 A1
(43) Pub. Date: Sep. 30, 2010

(54) Denture adhesive shield

(76) Inventors: Arthur L. Tudek, Glassport, PA (US); Renee R. Daugherty, New Kensington, PA (US)

Correspondence Address: Arthur L. Tudek, 507 Indiana Avenue, Glassport, PA, 15045, US

(21) Appl. No.: 12/661,191

(22) Filed: Mar. 12, 2010

Related U.S. Application Data
(60) Provisional application No. 61/211,340, filed on Mar. 30, 2009.

(51) Int. Cl. A61C 13/07

(52) U.S. Cl. 433/168.1

(57) ABSTRACT

Disclosed is a denture shield to prevent denture adhesive from coming in contact with the user's gums and/or oral mucosa including the palate. This shield has two important advantages, the first is the elimination of the hard and messy cleanup of the residue from the user's mouth and the second is the reduction of the adhesive chemicals into the user's system.

### BRIEF SUMMARY OF THE INVENTION

This invention consists of a thin film of porous paper similar to tea bag material to fit the contours of dentures. To utilize the shields, the user applies the needed adhesive to the dentures and places said formed shield over the adhesive which also adheres to said adhesive and then places the fixed unit into the mouth.

The adhesion power of the adhesive goes through the pores of said shield and adheres to the gums or palate of the user without the physical makeup of the adhesive coming in contact with the wearer's flesh. After the dentures need changing, the dentures are removed, the adhesive residue along with the shield remain on the dentures and can be scraped off with the thumb nail. A rinsing with water is in order to have a residue free mouth.

### BACKGROUND OF THE INVENTION

Dentures bonding aids are available is a variety of forms and makeup. The most common are adhesive creams and powders which have the most adhesion but are the ones that leave the messy residue on the user's gums in absense of this present invention.

There is another type of bonding aid that is labled “Sea Bond”, which is made from a derivative of sea weed. It is a textile pad that swells and softens when wetted with water, however, it does have the advantage of eliminating the messy residue but it does lack the adhesion power of the creams and powders. Furtheremore, the cost of said product is multiple times the cost of creams and powders than my present invention.

### SUMMARY OF THE INVENTION

The principal object of this present invention is to provide a thin film of porous paper to fit the contours of upper and lower dentures in combination with denture adhesive to hold dentures firmly while providing a health benefit of preventing the adhesives from entering the user's system.

Another important object is to provide the denture shields for users who prefer the low cost of adhesives that hold dentures the firmest of all and would welcome the advantage of eliminating the adhesive residue from the wearer's flesh.

These and other objects and advantages will be apparent as the drawing is viewed, wherein:

Fig. is a plan view of the upper denture shield.

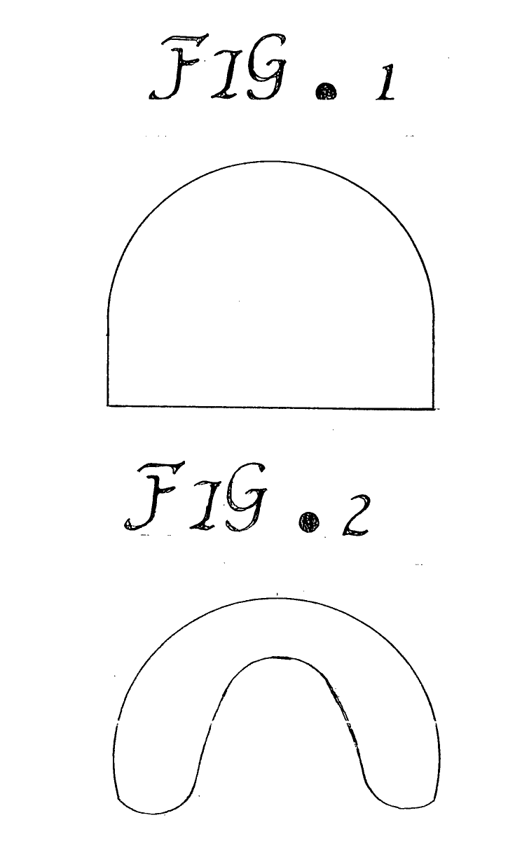

FIG. 2 is also a plan view of the lower denture shield.

### CROSS REFERENCE TO PRIOR ART

There are numerous denture liners with or without adhesive disclosed in prior art of the past, however, none have suggested a shield that provides the health benefit of preventing adhesives from entering the user's system and or the advantage of an easy and hygieneic clean-up of the residue.

We claim:

1. A dental health improvement for the users of dentures consisting of a thin, porous paper that has the composition of vegetable-wood product which some tea bags are manufactured, to fit over the insides of upper or lower dentures after adhesive was applied to the dentures, covering the adhesive thus preventing and blocking the adhesive from coming in contact with the user's flesh resulting in reducing or eliminating the intake of adhesive into the user's system and eliminating the adhesive residue that adheres to the gums or palate of the user.
